(19) United States
(12) Patent Application Publication
(10) Pub. No.: US 2019/0013105 A1
(43) Pub. Date: Jan. 10, 2019

(54) MUON-CATALYZED FUSION ON THIN-ATMOSPHERE PLANETS OR MOONS USING COSMIC RAYS FOR MUON GENERATIONS

(71) Applicant: Jerome Drexler, Los Altos Hills, CA (US)

(72) Inventor: Jerome Drexler, Los Altos Hills, CA (US)

(21) Appl. No.: 15/654,382

(22) Filed: Jul. 19, 2017

Related U.S. Application Data
(60) Provisional application No. 62/365,511, filed on Jul. 22, 2016.

(51) Int. Cl. G21B 3/00; G21B 1/23; G21B 1/19

(52) U.S. Cl. CPC G21B 3/004; B64G 9/00; G21B 1/19; G21B 1/23

(57) ABSTRACT

A method is provided for heating or lighting a designated local area of a planet, moon or other space body in the presence of an ambient flux of cosmic rays by employing either or both muon-catalyzed or particle-target fusion of deuterium-containing fuel material. A series of packages of the fuel are directed to a location that is a specified distance from the local area to be heated or illuminated, for example at a specified altitude above that local area. The fuel material is then released, e.g. chemical explosive, to form a localized cloud that is exposed to and interacts with the ambient flux of cosmic rays and with muons generated from the cosmic rays. The resulting nuclear micro-fusion produces energetic reaction products together with usable heat and light radiating from the localized cloud of material.

### CROSS-REFERENCE TO RELATED APPLICATION

This application claims priority under 35 U.S.C. 119(e) from prior U.S. provisional application 62/365,511, filed Jul. 22, 2016.

### TECHNICAL FIELD

The present invention relates to inducement or production of controlled nuclear fusion for use on surfaces of the Moon, Mars, and other planets or moons having little or no magnetic field and/or atmosphere, and in particular to muon-catalyzed micro-fusion as well as particle-target micro-fusion from ambient irradiation and bombardment with high-energy cosmic rays and their muon decay products.

### BACKGROUND ART

Muon-catalyzed fusion was observed by chance in late 1956 by Luis Alvarez and colleagues during evaluation of liquid-hydrogen bubble chamber images as part of accelerator-based particle decay studies. These were rare proton-deuteron fusion events that only occurred because of the natural presence of a tiny amount of deuterium (one part per 6400) in the liquid hydrogen. It was quickly recognized that fusion many orders of magnitude larger would occur with either pure deuterium or a deuterium-tritium mixture. However, John D. Jackson (Lawrence Berkeley Laboratory and Prof. Emeritus of Physics, Univ. of California, Berkeley) correctly noted that for useful power production there would need to be an energetically cheap way of producing muons. The energy expense of generating muons artificially in particle accelerators combined with their short lifetimes has limited its viability as an earth-based fusion source, since it falls short of breakeven potential.

Another controlled fusion technique is particle-target fusion which comes from accelerating a particle to sufficient energy so as to overcome the Coulomb barrier and interact with target nuclei. To date, proposals in this area depend upon using some kind of particle accelerator. Although some fusion events can be observed with as little as 10 KeV acceleration, fusion cross-sections are sufficiently low that accelerator-based particle-target fusion are inefficient and fall short of break-even potential.

It is known that abundant muons can be derived from the decay of cosmic rays passing through a planet's atmosphere. Cosmic rays are mainly high-energy protons (with some high-energy helium nuclei as well) having kinetic energies in excess of 300 MeV. Most cosmic rays have GeV energy levels, although some extremely energetic ones can exceed 10¹⁸ eV. FIG. 2 shows cosmic ray flux distribution at the Earth's surface after significant absorption by Earth' atmosphere has occurred. In near-Earth space, the alpha magnetic spectrometer (AMS-02) instrument aboard the International Space Station since 2011 has recorded an average of 45 million fast cosmic ray particles daily (approx. 500 per second). The overall flux of galactic cosmic ray protons (above earth's atmosphere) can range from a minimum of 1200 m⁻²s⁻¹sr⁻¹ to as much as twice that amount. (The flux of galactic cosmic rays entering our solar system, while generally steady, has been observed to vary by a factor of about 2 over an 11-year cycle according to the magnetic strength of the heliosphere.) In regions that are outside of Earth's protective magnetic field (e.g. in interplanetary space, or on planets or moons lacking a strong magnetic field), the cosmic ray flux is expected to be several orders of magnitude greater. As measured by the Martian Radiation Experiment (MARIE) aboard the Mars Odyssey spacecraft, average in-orbit cosmic ray doses were about 400-500 mSv per year, which is at least an order of magnitude higher than on Earth.

It is known that as cosmic rays lose energy upon collisions with atmospheric dust, and to a lesser extent atoms or molecules, they generate elementary particles, including pions and then muons, usually within a penetration distance of a few cm. Typically, hundreds of muons are generated per cosmic ray particle from successive collisions. For example, near sea level on Earth, the flux of muons generated by the cosmic rays' interaction by the atmosphere averages about 70 m⁻²s⁻¹sr⁻¹. The muon flux is even higher in the upper atmosphere. These relatively low flux levels on Earth reflect the fact that both Earth's atmosphere and geomagnetic field substantially shields our planet from cosmic ray radiation. Mars is a different story, having very little atmosphere (only 0.6% of Earth's pressure) and no magnetic field, so that cosmic ray flux and consequent muon generation at Mars' surface is expected to be very much higher than on Earth's surface.

In recent years, there have been proposals to send further spacecraft to Mars in 2018 and then manned space vehicles to Mars by 2025. One such development project is the Mars Colonial Transporter by the private U.S. company SpaceX with plans for a first launch in 2022 followed by flights with passengers in 2024. The United States has committed NASA to a long-term goal of human spaceflight and exploration beyond low-earth orbit, including crewed missions toward eventually achieving the extension of human presence throughout the solar system and potential human habitation on another celestial body (e.g., the Moon, Mars). As part of any manned exploration and human habitation of Mars, one or more forms of heating and lighting, and liquid water, will be needed for the habitats and life support.

### SUMMARY DISCLOSURE

A method for providing heating, illumination, or both to a designated local area of a planet, moon, or other space body in the presence of an ambient flux of cosmic rays comprises (a) directing a series of packages of deuterium-containing particle fuel material to a location that is a specified distance from a designated local area, and (b) releasing the deuterium-containing particle fuel material as a localized cloud, the fuel material being exposed to and interacting with the ambient flux of cosmic rays and muons generated from the cosmic rays to produce energetic reaction products together with usable heat and light for the designated local area.

For example, on Mars, the absence of a magnetic field and its thin atmosphere (0.6% of Earth's pressure) allows a substantial flux of cosmic rays to reach the planetary surface and its high mountains. Therefore, locating fusion target material (heavy water, liquid deuterium, lithium-6 deuteride, etc.) on Mars or any other planet or moon with a thin atmosphere can make use of the muon generation from such cosmic rays to catalyze fusion. The muons are available here for free and do not need to be generated artificially in an accelerator. One cosmic ray particle can generate hundreds of muons, and each muon can typically catalyze about 100 fusion reactions before it decays (the exact number depending on the muon “sticking” cross-section to any helium fusion products). Additionally, any remaining cosmic rays can themselves directly stimulate a fusion event by particle-target fusion, wherein the high energy cosmic ray particles (mostly protons, but also helium nuclei) bombard the relatively stationary target material.

Created by collisions of cosmic ray particles with atmospheric dust and molecules, muons are used in several ways in the present invention. The main reaction is in catalyzing fusion of two deuterium nuclei. The deuterium “fuel” may be supplied in the form of heavy water (D₂O) or liquid deuterium (D₂) or even solid Li⁶D. Other types of fusion reactions are also possible depending upon the target material. For example, the Li⁶D reaction is Li⁶−D→2He⁴+22.4 MeV, where much of the useful excess energy is carried as kinetic energy of the two helium nuclei (alpha particles). Additionally, when bombarded directly with cosmic rays, the lithium may be transmuted into tritium which could form the basis for some D-T micro-fusion reactions.

Since the amount of generated energy is on the order of kilowatts, which is very much less than the fusion energy outputs or yields typical of atomic weapons, “micro-fusion” is the term used here to refer to fusion energy outputs of not more than 10 gigajoules per second (2.5 tons of TNT equivalent per second), to thereby exclude runaway macro-fusion-type explosions.

In the present invention, muons from cosmic ray decay replace electrons in deuterium, allowing for a reduced size molecule because, as realized by Charles Frank in 1927, being about 200 times more massive than electrons, muons orbit much nearer to the central nucleus than the electron replaced. Muonic deuterium can come much closer to the nucleus of a similar neighboring atom with a probability of fusing deuterium nuclei, releasing energy. Once a muonic molecule is formed, nuclear fusion proceeds extremely rapidly (on the order of 10⁻¹⁰ sec). The muon is usually released to catalyze about 100 other fusion reactions during its short life (2 μs at rest, but longer at relativistic speeds generated by cosmic rays). Although D-D fusion reactions occur at a rate only 1% of D-T fusion, and produce only 20% of the energy by comparison, the freely available flux of cosmic ray generated muons on planets (such as Mars) or moons with thin atmospheres should be sufficient to yield sufficient energy output by muon-catalyzed fusion for practical use. Energetic protons, which make up about 90% of the cosmic rays, must have a collision energy loss of at least 300 MeV for a muon to be created. Most cosmic rays are energetic enough to create multiple muons (often several hundred) by successive collisions with atmospheric dust or with the atoms in a fusion target. Any cosmic rays that reach the Martian surface or target area with sufficient residual energy can also directly induce some nuclear fusion events by particle-target type fusion, supplementing those obtained from the muons.

The present invention achieves muon-catalyzed nuclear micro-fusion using deuterium-containing target material, and muons that are naturally created from ambient cosmic rays. Most cosmic rays are energetic enough to create multiple muons (often several hundred) by successive collisions with atmospheric dust or with the atoms in a target. In fact, most cosmic rays have GeV energies, although some extremely energetic ones can exceed 10¹⁸ eV and therefore potentially generate millions of muons. The optimum concentration of the target material for the muon-catalyzed fusion may be determined experimentally based on the particular abundance of cosmic rays with a view to maintaining a chain reaction of fusion events for producing adequate heat or illumination photons for the specified application while avoiding any possibility of runaway fusion in the muon rich environment (each muon can catalyze multiple fusion events, as many as 100, before it eventually decays).

At a minimum, since muon-catalyzed fusion, while recognized, is still an experimentally immature technology (since measurements have only been conducted to date on Earth using artificially generated muons from particle accelerators), various embodiments of the present invention can have research utility to demonstrate feasibility in environments beyond Earth's protective atmosphere and/or geomagnetic field, initially above Earth's atmosphere for trial purposes, and then on the Moon or the surface of Mars, in order to determine optimum parameters for various utilities in those environments. For example, the actual number of muon catalyzed fusion reactions for various types of target configurations and fusion fuel sources, and the amount of heat, illumination, or useful work that can be derived from such reactions, are still unknown and need to be fully quantified in order to improve the technology.

### BRIEF DESCRIPTION OF THE DRAWINGS

FIG. 1 is a schematic side view of a scheme for producing cosmic-ray and muon induced micro-fusion for heating and illumination of a local surface area, as well as a supply of liquid water by using the heat to melt surface ice.

FIG. 2 is a graph of cosmic ray flux at the Earth surface versus cosmic ray energy, after very significant cosmic ray absorption by Earth's atmosphere has occurred.

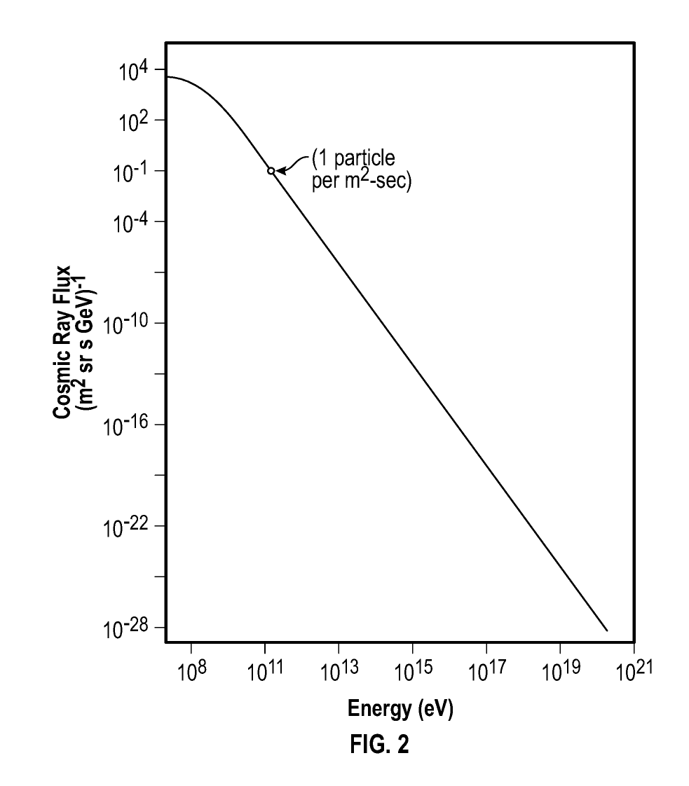

### DETAILED DESCRIPTION

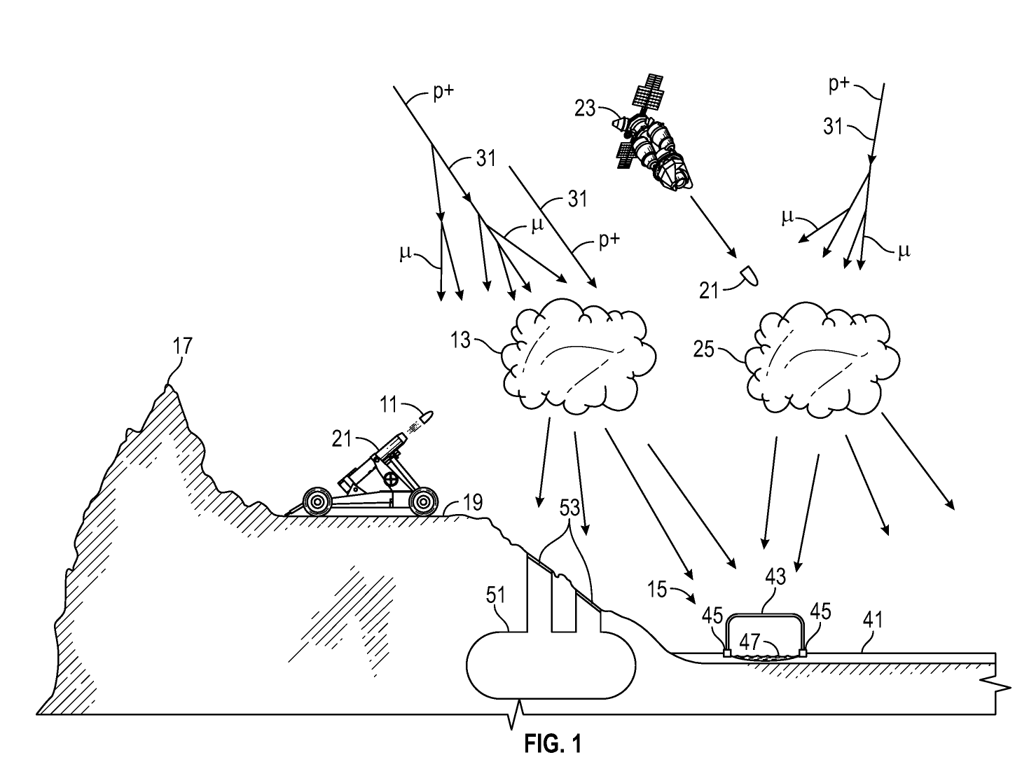

With reference to FIG. 1, one technique to provide heating and lighting is to project the micro-fusion target material 11 skyward and release it as a localized cloud 13 at a specified altitude above a designated local area 15 to be heated, illuminated, or both. For example, from the top of a mountain 17, one can send up “fuel” packages 11, much like fireworks or artillery, which then disperses the fusion material as a localized cloud 13 via chemical explosion. One might choose a mountain on Mars that is as much as 5-10 miles (8-16 kilometers) in elevation, possibly with a suitable 10-acre (4-hectare) flat plateau region 19 near the top for a shell projection site. A 120 mm stratosphere antiaircraft gun 21, or similar apparatus, can fire a series of projectiles 11, e.g. at least once every minute, about 3-5 miles (5-8 kilometers) high and up to 15-20 miles (25-30 kilometers) downrange in Mars' lower-gravity and thinner atmosphere. Alternatively, any convenient method that brings the material to the desired altitude can be employed. For example, packages 21 might be successively dropped from a satellite platform 23, preferably one in synchronous orbit so as to maintain its relative position above the designated surface location. The satellite-dropped packages 21 enter the atmosphere and release the material as a localized cloud 25 at a predetermined altitude.

The fuel can be D₂O ice crystals, droplets of (initially liquid) D₂, or even solid Li⁶D in powder form. The quantity of active fuel material needing to be released is generally small, since only a microgram of micro-fusion material consumed per second will produce a kilowatt of output. To assist muon formation, especially when D₂O or D₂ is used, the target package 11 or 21 may contain up to 20% by weight of added particles of fine sand or dust. (This is particularly important if one desires to create a similar fusion reaction over the Moon, which has no atmosphere.)

Besides D-D micro-fusion reactions from D₂O or D₂, other types of micro-fusion reactions may also occur when using Li⁶D material. Cosmic rays impacting the lithium-6 will generate tritium for D-T micro-fusion reactions. Additionally, direct cosmic ray collisions can cause Li⁶−D reactions via particle-target fusion. It should be noted that naturally occurring lithium can have an isotopic composition ranging anywhere from as little as 1.899% to about 7.794% Li⁶, with most samples falling around 7.4% to 7.6% Li⁶. Although LiD that has been made from natural lithium sources might be used in lower energy yield applications or to inhibit a runaway macro-fusion event, fuel material that has been enriched with greater proportions of Li⁶ is preferable for achieving greater energy output per microgram of fuel. (Lithium hydride is periodically of interest for hydrogen storage, but practical terrestrial applications have been thwarted by its chemical instability and its violent reactiveness in the presence of water. However, this should not be a problem on the Moon or Mars, where water is scarce and doesn't occur in liquid form.)

Packages 11 or 21 may be shielded to reduce or eliminate premature fusion events (e.g. during transport through space) until delivered to the desired location. Soon after the projectile 11 has reached peak altitude and is beginning its downward traversal the package releases its target material. For example, a chemical explosion can be used to locally disperse the fusion material. The dispersed cloud 13 of target material will slowly settle down above or downrange from the plateau 19 and be exposed to both cosmic rays 31 and their generated muons μ. As cosmic rays 31 collide with fusion targets and dust, they form muons μ that are captured by the deuterium and cause fusion. Other types of fusion reactions may also occur (e.g. D-T, using tritium generated by cosmic rays impacting the lithium; as well as Li⁶−D reactions from direct cosmic ray collisions).

The muon-catalyzed micro-fusion reactions, where the muons μ are generated from cosmic rays 31, may be used to create successive miniature suns shining from the clouds 13 or 25 on or near mountain tops 17 on Mars, much like a bright flare. The miniature suns shining upon the ground, a kind of “external” combustion in the sky, will illuminate and heat the local area 15 below. As such, they will function in much the same way the sun does to heat the atmosphere and ground surface, including any water ice 41 on the Martian surface, by infrared radiation. The amount of heat and light energy that is generated depends upon the quantity of fuel released and the quantity of available cosmic rays 31 and muons μ. An estimated 10¹⁵ individual micro-fusion reactions (less than 1 μg of fuel consumed) per second would be required for 1 kW output. But as each cosmic ray 31 can create hundreds of muons μ and each muon p can catalyze approximately 100 micro-fusion reactions, the available cosmic ray flux is believed to be sufficient for this purpose following research, development, and engineering efforts to optimize fuel release rates and altitude.

The needed rate of firing of fuel projectiles 11 or 21 depends on the amount of heat and light energy required, the dispersal rate of the fuel cloud 13 or 25, the amount of fusion obtained from the ambient cosmic ray and/or muon flux at the designated altitude of material cloud dispersion, and the efficiency of conversion of the micro-fusion products' kinetic energy into heat and light, but could be expected to be at least one shell per minute for the needed duration.

One application is to use the heat energy (infrared radiation) to melt surface water ice 41. The amount of heat needed will depend upon both initial ambient surface temperatures and the quantity of water to be heated. Inasmuch as the atmospheric pressure on Mars is too thin for water to exist in liquid form (water sublimates directly from solid to gas if pressure is less than 612 Pa), the target area 15 may have greenhouse structures 43 set up to raise the gas-vapor pressure immediately above the ice 41 and support melting. Pressure in the greenhouse structures need only be increased slightly. (At just 1200 Pa, boiling point has already increased to about 10° C.) The greenhouse structures 43 placed on the ice may be weighted around the bottom sides 45 to contain the liquid water 47 and supporting atmosphere. As the radiation from the muon-fusion generated mini-suns shines through the greenhouse 43, it heats the ice 41, while the greenhouse 43 also traps the infrared radiation so that the interior stays warm enough to keep the water 47 in liquid form until it can be drawn off and used.

Besides local heating and illumination of specified surface areas, the mini-suns may also serve as nighttime illumination of underground dwellings 51 via skylight roofing covers 53.

What is claimed is:

1. A method for providing heating, illumination, or both to a designated local area of a planet, moon, or other space body in the presence of an ambient flux of cosmic rays, comprising:
directing a series of packages of deuterium-containing particle fuel material to a location that is a specified distance from a designated local area;
dispersing the deuterium-containing particle fuel material as a localized cloud, the fuel material being exposed to and interacting with the ambient flux of cosmic rays and muons generated from the cosmic rays to produce energetic reaction products together with usable heat and light for the designated local area.

2. The method as in claim 1, wherein the packages are projected skyward and the fuel material is dispersed at a specified altitude above the designated local area.

3. The method as in claim 2, wherein the packages are artillery projectiles fired from a gun to an altitude of up to 5 miles (8 kilometers), and the fuel material is dispersed via chemical explosion.

4. The method as in claim 2, wherein the packages are projected skyward from a mountain top or plateau.

5. The method as in claim 1, wherein the packages are dropped from an orbiting platform and the fuel material is dispersed at a specified altitude above the designated local area.

6. The method as in claim 1, wherein dwellings and other structures in the designated local area are equipped with skylight roofing covers to receive the light from the energetic reactions in the localized cloud.

7. The method as in claim 1, wherein one or more greenhouse structures are set up over ice in the designated local area to trap infrared radiation from the received heat and light and to raise gas-vapor pressure within the greenhouse structures to promote melting.

8. The method as in claim 7, wherein each greenhouse structure is weighted around bottom sides thereof to contain liquid water from the melted ice within the structure.

9. The method as in claim 1, wherein the deuterium-containing particle fuel material comprises Li⁶D.

10. The method as in claim 1, wherein the deuterium-containing fuel material comprises D₂O.

11. The method as in claim 1, wherein the deuterium-containing fuel material comprises D₂.

12. The method as in claim 1, wherein the deuterium-containing fuel material is in solid powder form.

13. The method as in claim 1, wherein the deuterium-containing fuel material is in pellet or chip form.

14. The method as in claim 1, wherein the deuterium-containing fuel material is in frozen form.

15. The method as in claim 1, wherein the deuterium-containing fuel material is in liquid droplet form.

16. The method as in claim 1, wherein the deuterium-containing fuel material also contains up to 20% by weight of added particles of fine sand or dust.
